(19) United States
(12) Patent Application Publication
(10) Pub. No.: US 2013/0271400 A1
(43) Pub. Date: Oct. 17, 2013

(54) SHAKE UNLOCK MOBILE TOUCH DEVICE AND METHOD FOR UNLOCKING THE SAME

(71) Applicants: Po-Hung Yao, Hsinchu Country (TW); Wei-Chung Chao, Hsinchu Country (TW)

(72) Inventors: Po-Hung Yao, Hsinchu Country (TW); Wei-Chung Chao, Hsinchu Country (TW)

(21) Appl. No.: 13/828,050

(22) Filed: Mar. 14, 2013

(30) Foreign Application Priority Data
Apr. 16, 2012 (TW) 101113435

(51) Int. Cl. G06F 3/041

(52) U.S. Cl. CPC G06F 3/041
USPC 345/173

(57) ABSTRACT

A shake unlock method for unlocking a shake unlock mobile touch device has steps of displaying an initial unlock image, receiving a touch signal that occurs when the initial unlock image is touched, displaying a shaking control image and an unlock endpoint on the touch panel, receiving a series of continuous location coordinates after the mobile touch device is shaken and varying coordinates of the shaking control image according to the received series of continuous location coordinates, and unlocking a lock mode of the mobile touch device when detecting the coordinates of the shaking control image coincide with coordinates of the unlock endpoint. Accordingly, the drawback of unlocking a conventional mobile touch device arising from the difficulty of dragging an image with single-handed operation can be eliminated without requiring additional hardware equipment.

### BACKGROUND OF THE INVENTION

1. Field of the Invention

The present invention relates to a method for unlocking a mobile device and more particularly to a method for unlocking a mobile touch device using shake gestures.

2. Description of the Related Art

Conventional mobile devices, such as mobile phones, MP3 players, tablet computers and the like, normally provide operation buttons for users to operate. To prevent users from accidentally touching the operation buttons while carrying the mobile devices, a touch lock function is provided to lock the operation buttons from being inadvertently touched. When intending to operate the mobile devices again, users must follow some particular operational processes, for example, simultaneously or sequentially pressing two or three operation buttons, to unlock the mobile devices.

To keep abreast of technological development, many mobile devices are equipped with touch panels in replace of conventional mechanical buttons. Hence, the unlocking method of the mobile devices is also developed from button control to touch control. With reference to FIG. 14, to be unlocked, a conventional mobile touch device in a lock mode enters an unlocking process after receiving an unlock activation signal, such as when the touch panel detects a touch or receives a button touch signal. The touch panel then displays an unlock interface 90. The unlock interface 90 has an unlock image 91, an unlock endpoint 92 and a prompting path 93 connecting the unlock image 91 and the unlock endpoint 92. Users must use a finger to touch the unlock image 91 and drag the unlock image 91 to the unlock endpoint 92 through the prompting path 93. The conventional mobile touch device is unlocked only after the unlocking process is completed.

As the unlocking operation of the conventional mobile touch device depends on the process of dragging the unlock image 91 to the unlock endpoint 92 along the prompting path 93 as shown in FIG. 14, when a hand of a user holds the mobile touch device, the thumb is subject to moving restriction and inconveniently drags the unlock image to complete the unlocking process, which should be finished by a finger of the other hand. When one hand of the user carries a bag or any other object, it is inconvenient for both hands of the user to complete the dragging motion and it oftentimes happens that users fail to answer the call in time. Voice recognition or optical pattern recognition (cornea recognition) are introduced as the latest unlocking solutions. However, the voice recognition has a relatively low recognition rate and is prone to the influence of noise in the environment, and the optical pattern recognition significantly increases the cost and therefore still has a low market acceptance now.

### SUMMARY OF THE INVENTION

An objective of the present invention is to provide a shake unlock mobile touch device and a shake unlock method for unlocking a shake unlock mobile touch device and capable of easily unlocking a shake unlock mobile touch device with single-handed operation.

To achieve the foregoing objective, the shake unlock mobile touch device has a lock mode, a touch panel and a master controller.

The lock mode is configured in the shake unlock mobile touch device.

The touch panel is adapted for users' operation and outputs a touch signal.

The master controller has a gravity sensing module and a shake unlock procedure.

The gravity sensing module outputs a series of continuous location coordinates corresponding to a shaking motion of the mobile touch device after sensing that the mobile touch device is shaken.

The shake unlock procedure is built in the master controller, is preset with an initial unlock image, a shaking control image and an unlock endpoint, and has steps of:

displaying the initial unlock image on the touch panel;

receiving the touch signal from the touch panel that occurs when the initial unlock image is touched, and then displaying the shaking control image and the unlock endpoint on the touch panel;

receiving the series of continuous location coordinates outputted from the gravity sensing module and varying coordinates of the shaking control image displayed on the touch panel according to the received series of continuous location coordinates; and

unlocking the lock mode when detecting the coordinates of the shaking control image coincide with coordinates of the unlock endpoint.

To achieve the foregoing objective, alternatively, the shake unlock mobile touch device has a lock mode, a touch panel, and a master controller.

The lock mode is configured in the shake unlock mobile touch device.

The touch panel is adapted for users' operation and outputs a touch signal.

The master controller has a gravity sensing module and a shake unlock procedure.

The gravity sensing module outputs a series of continuous location coordinates corresponding to a shaking motion of the mobile touch device after sensing that the mobile touch device is shaken.

The shake unlock procedure is built in the master controller, is preset with an initial unlock image, an unlock path, and a unlock path image, and has steps of:

displaying the initial unlock image on the touch panel;

receiving the touch signal from the touch panel that occurs when the initial unlock image is touched, and then displaying the unlock path image on the touch panel;

receiving the series of continuous location coordinates outputted from the gravity sensing module; and

unlocking the lock mode after determining that a path formed by the series of continuous location coordinates matches the unlock path stored in the memory unit.

When users intend to unlock the lock mode of the shake unlock mobile touch device, two steps need to be performed as follows.
1. Touch the initial unlock image to ensure that users indeed enter an unlocking process and the users just need to touch the initial unlock image.
2. Shake the shake unlock mobile touch device to move the shaking control image to the unlock endpoint or shake the shake unlock mobile touch device according to the unlock path image for the gravity sensing module to output a series of continuous location coordinates as a basis of unlocking the mobile touch device if the path formed by the continuous location coordinates coincide with the unlock path.

Hence, users can perform the two foregoing steps to replace the conventional unlocking method using a dragging operation. Users can hold a mobile touch device with a single hand and easily unlock the mobile touch device with a single-handed operation, rendering operational convenience. As the touch panel and the gravity sensing module are available to currently-existing mobile touch devices, no additional hardware cost is required for the mobile touch devices.

To achieve the foregoing objective, the shake unlock method for unlocking a mobile touch device has steps of:

displaying an initial unlock image;

receiving a touch signal that occurs when the initial unlock image is touched;

displaying a shaking control image and an unlock endpoint on the touch panel;

receiving a series of continuous location coordinates after the mobile touch device is shaken and varying coordinates of the shaking control image according to the received series of continuous location coordinates; and

unlocking a lock mode of the mobile touch device when detecting the coordinates of the shaking control image coincide with coordinates of the unlock endpoint.

To achieve the foregoing objective, alternatively, the shake unlock method for unlocking a mobile touch device has steps of:

presetting an unlock path;

displaying an initial unlock image;

receiving a touch signal that occurs when the initial unlock image is touched;

displaying a shaking control image corresponding to the unlock path;

receiving a series of continuous location coordinates after the mobile touch device is shaken and determining if a path formed by the series of continuous location coordinates matches the unlock path, and if positive, unlocking a lock mode of the mobile touch device.

Other objectives, advantages and novel features of the invention will become more apparent from the following detailed description when taken in conjunction with the accompanying drawings.

### BRIEF DESCRIPTION OF THE DRAWINGS

FIG. 1 is functional block diagram of a shake unlock mobile touch device in accordance with the present invention;

FIG. 2 is a flow diagram of a first embodiment of a method for unlocking a shake unlock mobile touch device in accordance with the present invention;

FIG. 3 is an operational schematic diagram illustrating a shake unlock mobile touch device during a step of the method in FIG. 2 for displaying an initial unlock image;

FIG. 4 is an operational schematic diagram illustrating a shake unlock mobile touch device during a step of the method in FIG. 2 for displaying a shaking control image and an unlock endpoint;

FIG. 5A is an operational schematic diagram illustrating when the shaking control image of the shake unlock mobile touch device in FIG. 4 is shaken to move to the unlock endpoint;

FIG. 5B is another operational schematic diagram illustrating when the shaking control image of the shake unlock mobile touch device in FIG. 4 is shaken to move to the unlock endpoint;

FIG. 5C is a relationship curve between coordinates of the movement of the shaking control image in FIG. 5A continuously outputted from a gravity sensing module and time;

FIG. 5D is a relationship curve between coordinates of the movement of the shaking control image in FIG. 5B continuously outputted from a gravity sensing module and time;

FIG. 6 is an operational schematic diagram illustrating a shake unlock mobile touch device during a step of the method in FIG. 2 for unlocking the mobile touch device;

FIG. 7 is a flow diagram of a second embodiment of a method for unlocking a shake unlock mobile touch device in accordance with the present invention;

FIG. 8 is a first operational schematic diagram illustrating a shake unlock mobile touch device during a step of the method in FIG. 7 for displaying an unlock path;

FIG. 9 is an operational schematic diagram illustrating a shake unlock mobile touch device during a step of the method in FIG. 7 for shaking the mobile touch device according to the unlock path in FIG. 8;

FIG. 10 is a second operational schematic diagram illustrating a shake unlock mobile touch device during a step of the method in FIG. 7 for displaying an unlock path;

FIG. 11 is an operational schematic diagram illustrating when the shake unlock mobile touch device is moved along the unlock path in FIG. 10;

FIG. 12 is a third operational schematic diagram illustrating a shake unlock mobile touch device during a step of the method in FIG. 7 for displaying an unlock path;

FIG. 13 is an operational schematic diagram illustrating when the mobile touch device is moved along the unlock path in FIG. 12; and

FIG. 14 is an operational schematic diagram illustrating a method for unlocking a conventional mobile touch device.

### DETAILED DESCRIPTION OF THE INVENTION

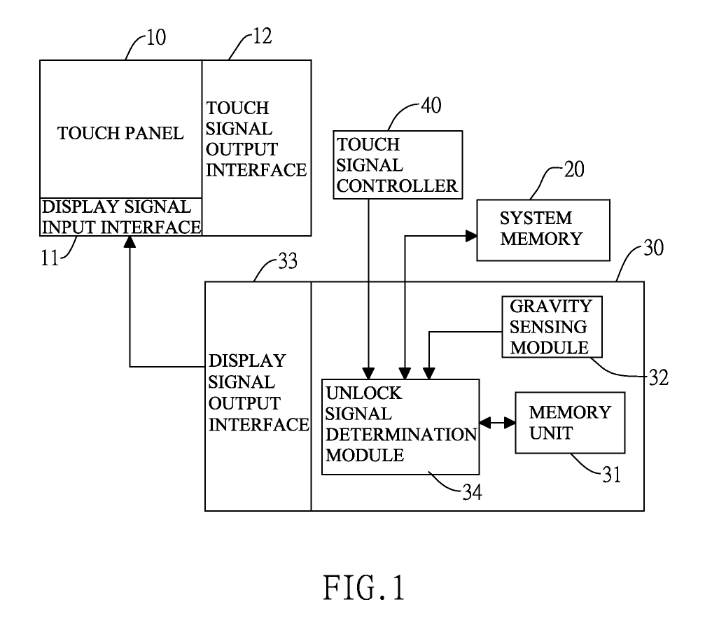

With reference to FIG. 1, a shake unlock mobile touch device in accordance with the present invention has a touch panel 10, a system memory 20 and a master controller 30.

The touch panel 10 has a display signal input interface 11 and a touch signal output interface 12, and outputs a touch signal through the touch signal output interface 12 after sensing a user's touch point.

The system memory 20 has a lock mode configured therein.

The master controller 30 is electronically connected to the touch panel 10 and has a memory unit 31, a gravity sensing module 32, a display signal output interface 33, and an unlock signal determination module 34.

The memory unit 31 stores an initial unlock image, an unlock path, an unlock path image, a shaking control image and an unlock endpoint. The gravity sensing module 32 outputs a series of continuous location coordinates after sensing that the mobile touch device is shaken. The display signal output interface 33 is connected with the display signal input interface 11 of the touch panel 10. The unlock signal determination module 34 is connected with the touch signal output interface 12 of the touch panel 10, the system memory 20, the gravity sensing module 32, the memory unit 31 and the display signal output interface 33, and is built in with a shake unlock procedure. In the present embodiment, the unlock signal determination module 34 is connected to the touch signal output interface 12 of the touch panel 10 through a touch signal controller 40.

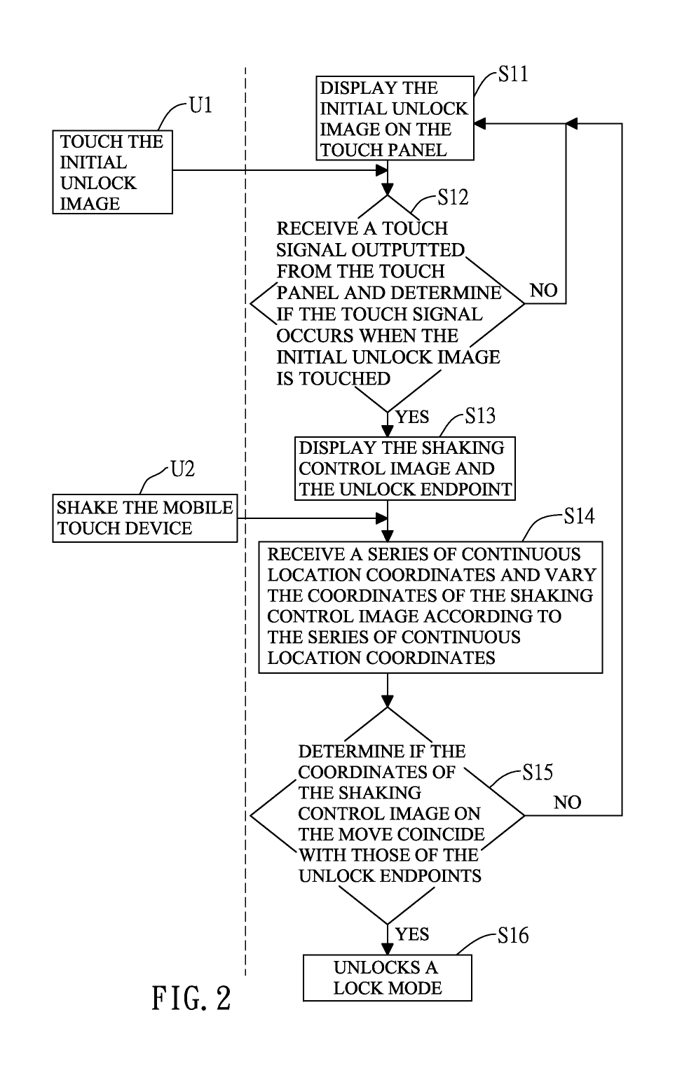

With reference to FIG. 2, a first embodiment of a method for unlocking a shake unlock mobile touch device in accordance with the present invention has the following steps.

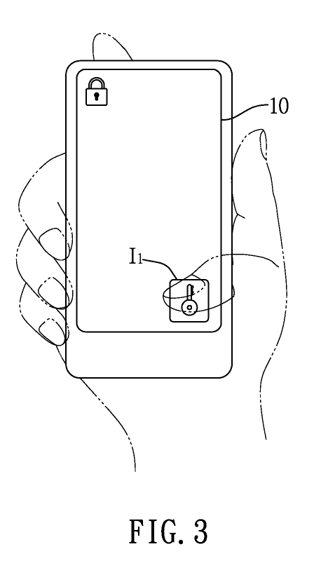

Step S11: The unlock signal determination module 34 reads the initial unlock image and outputs the initial unlock image to the touch panel 10 through the display signal output interface 33 for the touch panel 10 to display the initial unlock image. With reference to FIG. 3, the touch panel 10 displays the initial unlock image I₁ thereon. The initial unlock image I₁ can be preferably positioned on a right bottom corner of the touch panel 10 for users to touch the touch panel 10 when holding the mobile touch device with the right hand. The initial unlock image I₁ can be also positioned on a left bottom corner of the touch panel 10 to facilitate the operation of left-handed users, or can occupy the entire screen of touch panel for the operation of both left-handed and right-handed users.

Step 12: The unlock signal determination module 34 receives the touch signal outputted from the touch panel 10 and determines if the touch signal occurs when the initial unlock image I₁ is touched; if negative, resume Step 11; and if positive, go to next step.

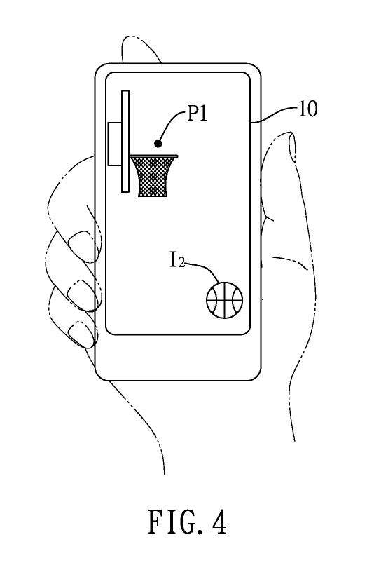

Step 13: The unlock signal determination module 34 reads the shaking control image I₂, the unlock endpoint P₁ and coordinates corresponding to the shaking control image I₂ and the unlock endpoint P₁ from the memory unit 31 and outputs the read information to the touch panel 10 through the display signal output interface 33 for the touch panel 10 to display as shown in FIG. 4. The shaking control image I₂ and the unlock endpoint P₁ are displayed on the corresponding coordinates thereof. As the respective coordinates of the shaking control image I₂ and the unlock endpoint P₁ are different, the shaking control image I₂ and the unlock endpoint P₁ are displayed on two different positions on the touch panel 10.

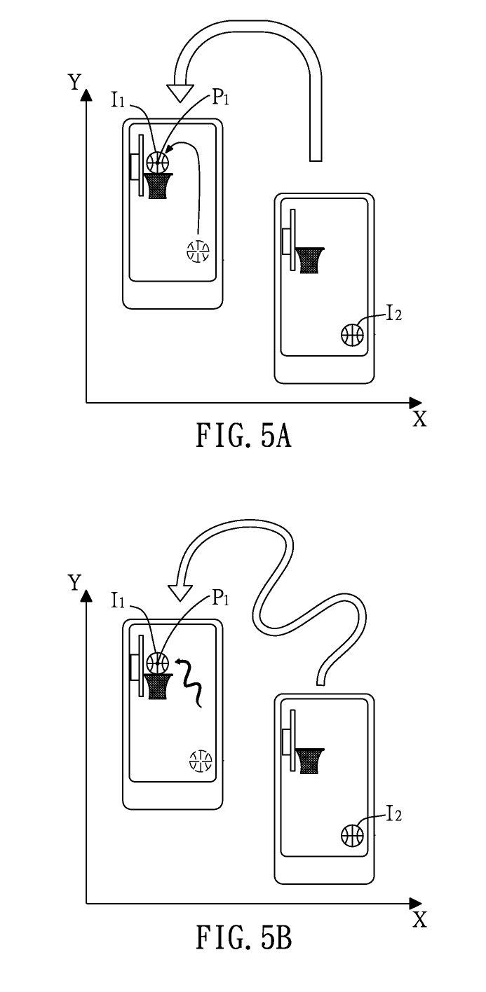

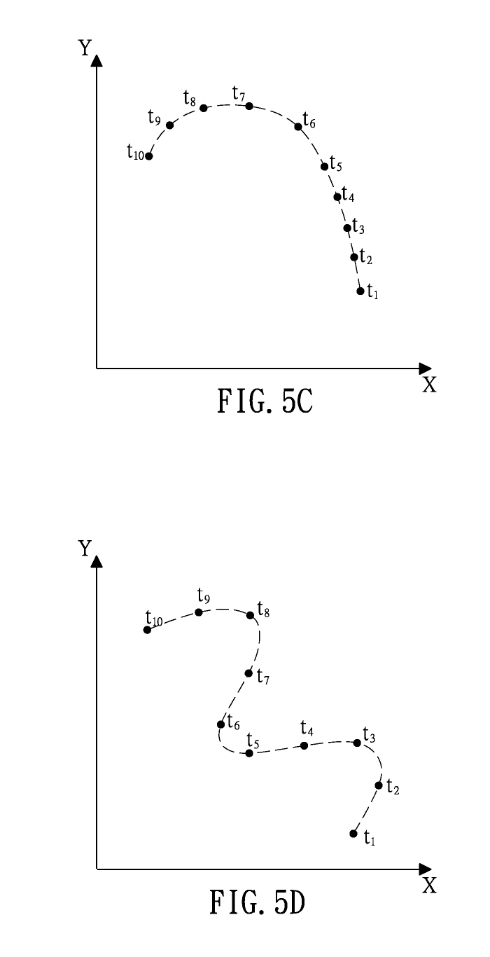

Step 14: The unlock signal determination module 34 receives a series of continuous location coordinates outputted from the gravity sensing module 32 and varies the coordinates of the shaking control image I₂ displayed on the touch panel 10 according to a path variation represented by the series of continuous location coordinates as shown in FIGS. 5A and 5B. When the mobile touch device is moved along the paths indicated in FIGS. 5A and 5B, the gravity sensing module 32 senses that the mobile touch device is shaken and outputs a series of continuous location coordinates represented by t₁˜t₁₀ in FIGS. 5C and 5D according to the shaking motions of the mobile touch device. The coordinates of the displayed shaking control image I₂ vary with the series of continuous location coordinates outputted by the gravity sensing module 32.

Step 15: The unlock signal determination module 34 determines if the coordinates of the shaking control image I₂ on the move coincide with those of the unlock endpoint P₁.

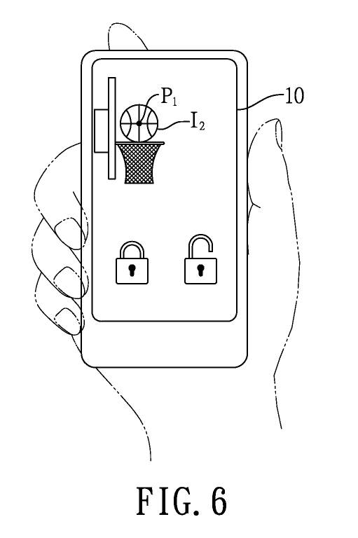

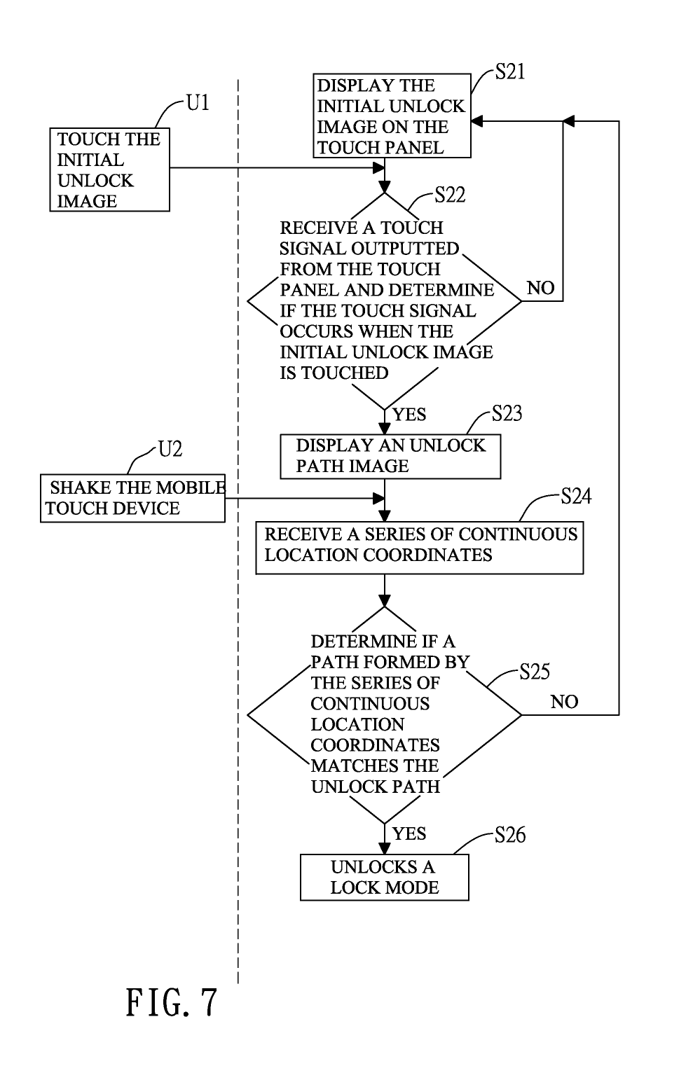

Step 16: If the determination result in Step 15 is positive, the unlock signal determination module 34 unlocks the lock mode configured in the system memory 20 as shown in FIG. 6, and if negative, the unlock signal determination module 34 returns to Step 11 if the coordinates of the shaking control image do not coincide with those of the unlock endpoint P₁ after a preset waiting time.

As indicated in FIG. 2, if the users intend to unlock the lock mode, two steps required to be performed are summarized as follows.

Step U1: Touch the initial unlock image I₁. In relative to image-dragging operation, the user's thumb is not required to slide on the touch panel 10 in Step U1 and even a thumb holding the mobile touch device can complete Step U1. The operation is more convenient and initiates the unlocking process due to accidental touch irrespective of whether the initial unlock image is located on the left bottom corner, on the right bottom corner, or on the entire screen of the touch panel 10.

Step U2: Shake the mobile touch device. Move the shaking control image I₂ to the unlock endpoint P₁ in completion of the unlocking process. Step U2 can be performed by using one hand to hold and shake the mobile touch device.

With reference to FIG. 7, a second embodiment of a method for unlocking a shake unlock mobile touch device in accordance with the present invention can also senses shaking motion to unlock and substantially differs from the foregoing embodiment in that the present embodiment further displays an unlock path image on the touch panel 10 to instruct users to shake according to a path indicated by the unlock path image. The shake unlock procedure has the following steps.

Step 21: Read the initial unlock image I₁ from the memory unit 31, and output the initial unlock image I₁ to the touch panel 10 through the display signal output interface 33 for the touch panel 10 to display the initial unlock image.

Step 22: Receive a touch signal outputted from the touch panel 10, determine if the touch signal is generated when the initial unlock image I1 is touched; if negative, resume Step 21, and if positive, go to next step.

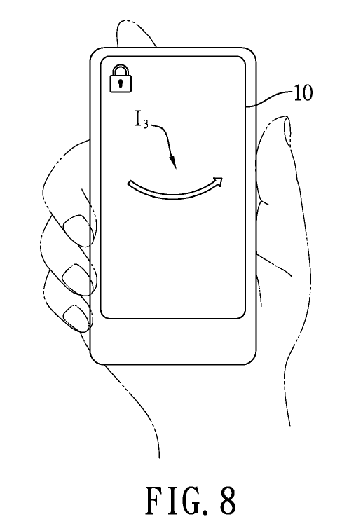

Step S23: Read the unlock path image I₃ stored in the memory unit 31, and output the unlock path image I₃ to the touch panel 10 for the touch panel 10 to display the unlock path image I₃ as shown in FIG. 8.

Step S24: Receive a series of continuous location coordinates outputted from the gravity sensing module 32.

Step S25: Determine if a path formed by the series of continuous location coordinates matches the unlock path stored in the memory unit 31.

Step 26: If the determination result in Step S25 is positive, unlock the lock mode configured in the system memory 20, and if negative, return to step S21.

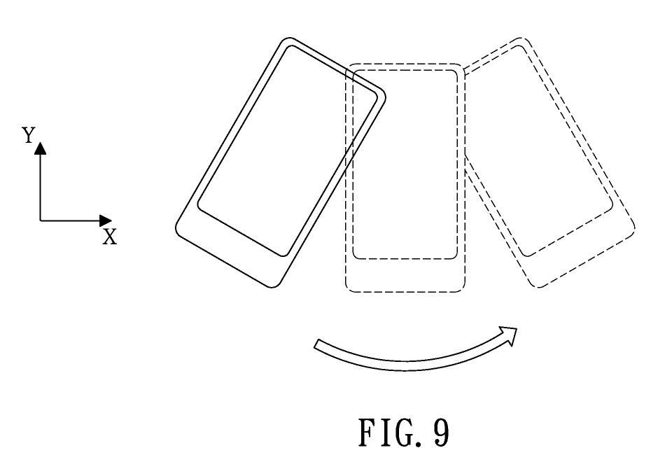

As shown in FIGS. 5A to 5C, as the gravity sensing module 32 outputs a series of continuous location coordinates when the mobile touch device is moved, determining if a moving path indicated by the series of continuous location coordinates matches the unlock path provides judgment for users to know if the mobile touch device is shaken according to the instruction indicated by the unlock path image I₃. With reference to FIG. 9, if the moving path of the mobile touch device matches the unlock path, the mobile touch device is unlocked.

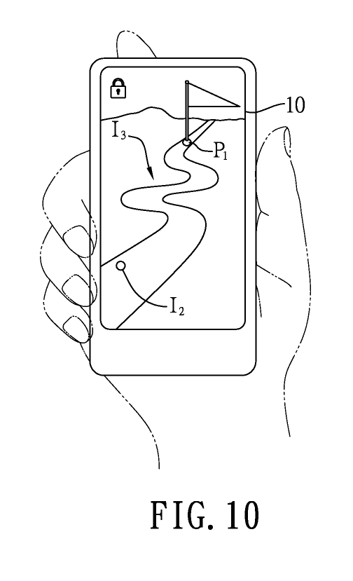

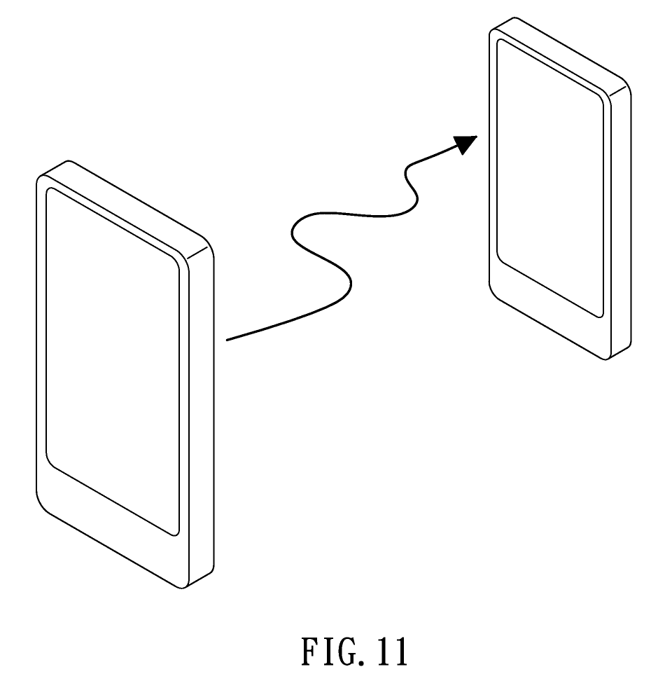

With reference to FIG. 10, as application software in a mobile touch device adds more value to the mobile touch device, the present invention further incorporates a game application into the mobile touch device to increase the fun of users in using the mobile touch device. The method further displays the shaking control image I₂ and the unlock endpoint P₁ in addition to the unlock path image I₃ in Step S23, and varies the coordinates of the displayed shaking control image I₂ with a series of continuous location coordinates received in Step S24, providing more fun to users in viewing the track formed by shaking the mobile touch device.

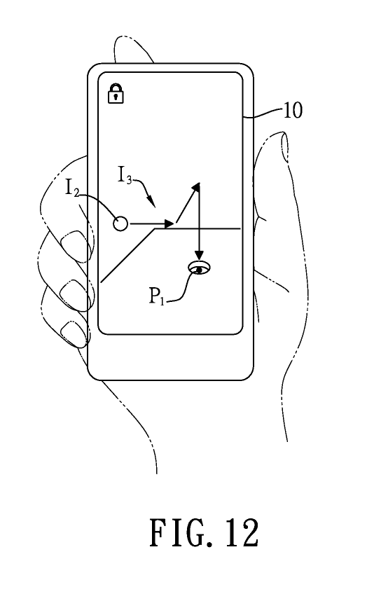

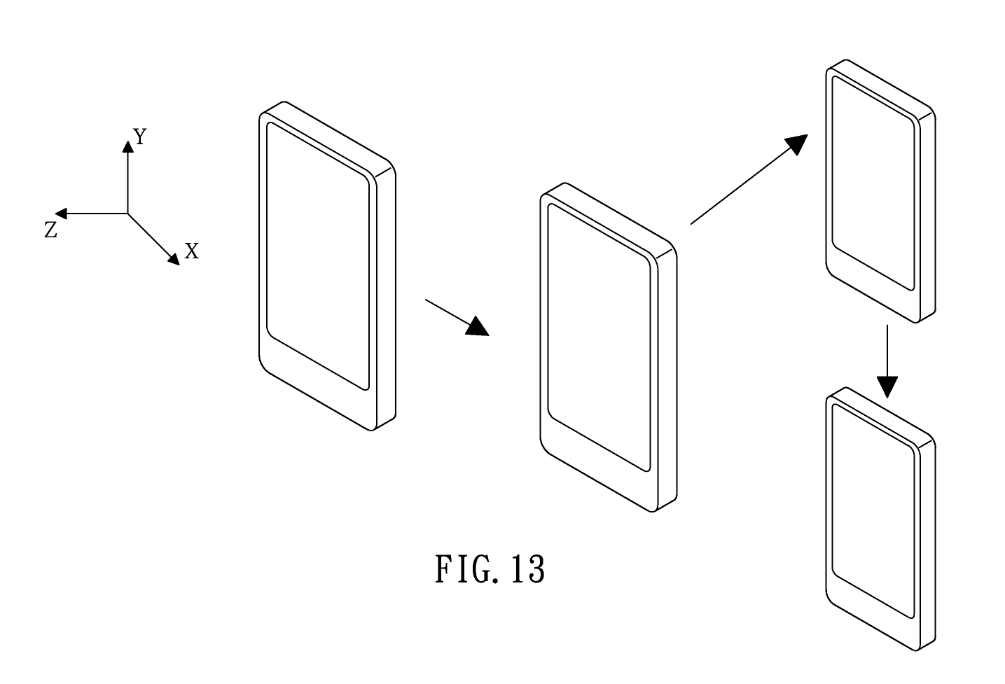

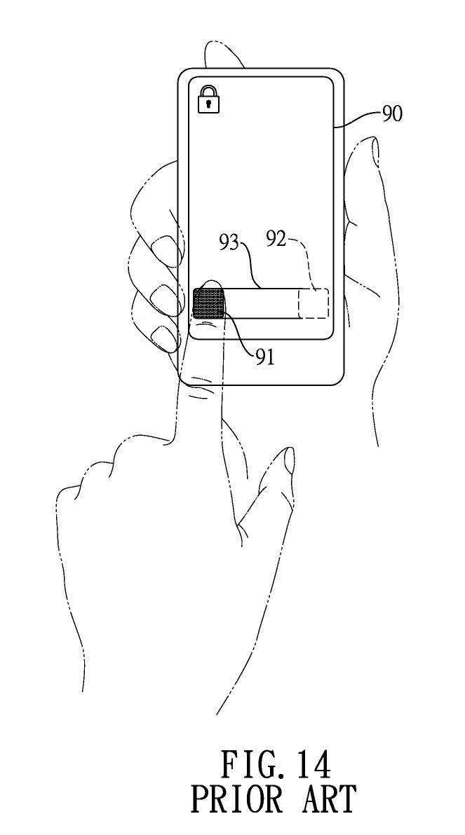

With reference to FIGS. 10 and 11, when users intend to move a golf ball forward according to the path instructed in a leisure-type game, the operation is performed only on a two-dimensional plane defined by X and Z axes. The gravity sensing module 32 only outputs a series of continuous coordinates in at least two coordinate axes. To diversify the shaking operation and increase the operational pleasure, the gravity sensing module 32 can further output a series of continuous location coordinates in three coordinate axes to display a three-dimensional path image as shown in FIGS. 12 and 13 for users to shake and unlock the mobile touch device in a three-dimensional space.

In sum, the present invention not only allows users to easily unlock a shake unlock mobile touch device with single-handed operation but also provides various leisure-type game applications to application developers. Accordingly, users can enjoy the fun of playing the leisure-type game applications without adding additional expensive hardware and increasing the hardware cost of a shake unlock mobile touch device.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A shake unlock mobile touch device, comprising:
a lock mode configured therein;
a touch panel adapted for users' operation and outputting a touch signal; and
a master controller electronically connected to the touch panel and having:
a gravity sensing module outputting a series of continuous location coordinates corresponding to a shaking motion of the mobile touch device after sensing that the mobile touch device is shaken; and
a shake unlock procedure built in the master controller, preset with an initial unlock image, a shaking control image and an unlock endpoint, and comprising steps of:
displaying the initial unlock image on the touch panel;
receiving the touch signal from the touch panel that occurs when the initial unlock image is touched, and then displaying the shaking control image and the unlock endpoint on the touch panel;
receiving the series of continuous location coordinates outputted from the gravity sensing module and varying coordinates of the shaking control image displayed on the touch panel according to the received series of continuous location coordinates; and
unlocking the lock mode when detecting the coordinates of the shaking control image coincide with coordinates of the unlock endpoint.

2. The shake unlock mobile touch device as claimed in claim 1, further comprising a system memory having the lock mode configured in the system memory, wherein
the touch panel has a display signal input interface and a touch signal output interface, and outputs the touch signal through the touch signal output interface; and
the master controller further has:
a memory unit storing the initial unlock image, the shaking control image and the unlock endpoint;
a display signal output interface connected to the display signal input interface of the touch panel; and
an unlock signal determination module connected to the touch signal output interface of the touch panel, the system memory, the gravity sensing module, the memory unit, and the display signal output interface, and built in with the shake unlock procedure.

3. The shake unlock mobile touch device as claimed in claim 2, wherein the unlock signal determination module is connected to the touch signal output interface of the touch panel through a touch signal controller.

4. The shake unlock mobile touch device as claimed in claim 2, wherein the shake unlock procedure has steps of:
reading the initial unlock image in the memory unit, and outputting the initial unlock image to the touch panel through the display signal output interface for the touch panel to display the initial unlock image;
receiving the touch signal outputted from the touch panel and determining if the touch signal occurs when the initial unlock image is touched, and if negative, resuming the step of reading the initial unlock image;
reading the shaking control image, the unlock endpoint and coordinates corresponding to the shaking control image and the unlock endpoint from the memory unit and outputting the read information to the touch panel through the display signal output interface for the touch panel to display the shaking control image and the unlock endpoint on the coordinates corresponding to the shaking control image and the unlock endpoint, wherein, the shaking control image and the unlock endpoint are displayed on two different positions on the touch panel;
receiving the series of continuous location coordinates outputted from the gravity sensing module and varying the coordinates of the shaking control image displayed on the touch panel according to the series of continuous location coordinates; and
determining if the coordinates of the shaking control image on the move coincide with the coordinates of the unlock endpoint, if positive, unlocking the lock mode configured in the system memory, and if negative, returning to the step of displaying the initial unlock image if the coordinates of the shaking control image do not coincide with the coordinates of the unlock endpoint after a preset waiting time.

5. The shake unlock mobile touch device as claimed in claim 3, wherein the shake unlock procedure has steps of:
reading the initial unlock image in the memory unit, and outputting the initial unlock image to the touch panel through the display signal output interface for the touch panel to display the initial unlock image;
receiving the touch signal outputted from the touch panel and determining if the touch signal occurs when the initial unlock image is touched, and if negative, resuming the step of reading the initial unlock image;
reading the shaking control image, the unlock endpoint and coordinates corresponding to the shaking control image and the unlock endpoint from the memory unit and outputting the read information to the touch panel through the display signal output interface for the touch panel to display the shaking control image and the unlock endpoint on the coordinates corresponding to the shaking control image and the unlock endpoint, wherein, the shaking control image and the unlock endpoint are displayed on two different positions on the touch panel;
receiving the series of continuous location coordinates outputted from the gravity sensing module and varying the coordinates of the shaking control image displayed on the touch panel according to the series of continuous location coordinates; and
determining if the coordinates of the shaking control image on the move coincide with the coordinates of the unlock endpoint, if positive, unlocking the lock mode configured in the system memory, and if negative, returning to the step of displaying the initial unlock image if the coordinates of the shaking control image do not coincide with the coordinates of the unlock endpoint after a preset waiting time.

6. A shake unlock mobile touch device, comprising:
a lock mode configured therein;
a touch panel adapted for users' operation and outputting a touch signal; and
a master controller electronically connected to the touch panel and having:
a gravity sensing module outputting a series of continuous location coordinates corresponding to a shaking motion of the mobile touch device after sensing that the mobile touch device is shaken; and
a shake unlock procedure built in the master controller, preset with an initial unlock image, an unlock path, and an unlock path image, and comprising steps of:
displaying the initial unlock image on the touch panel;
receiving the touch signal from the touch panel that occurs when the initial unlock image is touched, and then displaying the unlock path image on the touch panel;
receiving the series of continuous location coordinates outputted from the gravity sensing module; and
unlocking the lock mode after determining that a path formed by the series of continuous location coordinates matches the unlock path stored in the master controller.

7. The shake unlock mobile touch device as claimed in claim 6, further comprising a system memory having the lock mode configured in the system memory, wherein
the touch panel has a display signal input interface and a touch signal output interface, and outputs the touch signal through the touch signal output interface;
the master controller further has:
a memory unit storing the initial unlock image, the unlock path, and the unlock path image;
a display signal output interface connected to the display signal input interface of the touch panel; and
an unlock signal determination module connected to the touch signal output interface of the touch panel, the system memory, the gravity sensing module, the memory unit, and the display signal output interface, and built in with the shake unlock procedure.

8. The shake unlock mobile touch device as claimed in claim 7, wherein the unlock signal determination module is connected to the touch signal output interface of the touch panel through a touch signal controller.

9. The shake unlock mobile touch device as claimed in claim 7, wherein the shake unlock procedure has steps of:
reading the initial unlock image in the memory unit, and outputting the initial unlock image to the touch panel through the display signal output interface for the touch panel to display the initial unlock image;
receiving the touch signal outputted from the touch panel and determining if the touch signal occurs when the initial unlock image is touched, and if negative, resuming the step of reading the initial unlock image;
reading the unlock path image and coordinates corresponding to the unlock path image from the memory unit and outputting the unlock path image to the touch panel for the touch panel to display the unlock path image; and
receiving the series of continuous location coordinates outputted from the gravity sensing module and determining if a path formed by the series of continuous location coordinates matches the unlock path stored in the memory unit, if positive, unlocking the lock mode configured in the system memory, and if negative, returning to the step of displaying the initial unlock image.

10. The shake unlock mobile touch device as claimed in claim 8, wherein the shake unlock procedure has steps of:
reading the initial unlock image in the memory unit, and outputting the initial unlock image to the touch panel through the display signal output interface for the touch panel to display the initial unlock image;
receiving the touch signal outputted from the touch panel and determining if the touch signal occurs when the initial unlock image is touched, and if negative, resuming the step of reading the initial unlock image;
reading the unlock path image and coordinates corresponding to the unlock path image from the memory unit and outputting the unlock path image to the touch panel for the touch panel to display the unlock path image; and
receiving the series of continuous location coordinates outputted from the gravity sensing module and determining if a path formed by the series of continuous location coordinates matches the unlock path stored in the memory unit, if positive, unlocking the lock mode configured in the system memory, and if negative, returning to the step of displaying the initial unlock image.

11. The shake unlock mobile touch device as claimed in claim 9, wherein
the memory unit further stores a shaking control image and an unlock endpoint; and
the shake unlock procedure further displays the shaking control image and the unlock endpoint in the step of reading the unlock path image, and varies coordinates of the shaking control image displayed on the touch panel according to the series of continuous location coordinates in the step of receiving the series of continuous location coordinates.

12. The shake unlock mobile touch device as claimed in claim 10, wherein
the memory unit further stores a shaking control image and an unlock endpoint; and
the shake unlock procedure further displays the shaking control image and the unlock endpoint in the step of reading the unlock path image, and varies coordinates of the shaking control image displayed on the touch panel according to the series of continuous location coordinates in the step of receiving the series of continuous location coordinates.

13. The shake unlock mobile touch device as claimed in claim 11, wherein the gravity sensing module outputs the series of continuous location coordinates in at least two coordinate axes.

14. The shake unlock mobile touch device as claimed in claim 12, wherein the gravity sensing module outputs the series of continuous location coordinates in at least two coordinate axes.

15. The shake unlock mobile touch device as claimed in claim 11, wherein the gravity sensing module outputs the series of continuous location coordinates in three coordinate axes.

16. The shake unlock mobile touch device as claimed in claim 12, wherein the gravity sensing module outputs the series of continuous location coordinates in three coordinate axes.

17. A shake unlock method for unlocking a mobile touch device, comprising steps of:
displaying an initial unlock image;
receiving a touch signal that occurs when the initial unlock image is touched;
displaying a shaking control image and an unlock endpoint on the touch panel;
receiving a series of continuous location coordinates after the mobile touch device is shaken and varying coordinates of the shaking control image according to the received series of continuous location coordinates; and
unlocking a lock mode of the mobile touch device when detecting the coordinates of the shaking control image coincide with coordinates of the unlock endpoint.

18. The shake unlock method as claimed in claim 17, wherein in the step of unlocking the lock mode, the method returns to the step of displaying the initial unlock image if the coordinates of the shaking control image do not coincide with the coordinates of the unlock endpoint after a preset waiting time.

19. A shake unlock method unlocking a mobile touch device, comprising steps of:
presetting an unlock path;
displaying an initial unlock image;
receiving a touch signal that occurs when the initial unlock image is touched;
displaying a shaking control image corresponding to the unlock path;
receiving a series of continuous location coordinates after the mobile touch device is shaken and determining if a path formed by the series of continuous location coordinates matches the unlock path, and if positive, unlocking a lock mode of the mobile touch device.

20. The shake unlock method as claimed in claim 19, further comprising a step of
presetting a shaking control image and an unlock endpoint before the step of presetting the unlock path, wherein the method further displays the shaking control image and the unlock endpoint in the step of displaying the initial unlock path image, and varies coordinates of the shaking control image according to the series of continuous location coordinates in the step of receiving a series of continuous location coordinates.
